(19) United States
(12) Patent Application Publication
(10) Pub. No.: US 2012/0074086 A1
(43) Pub. Date: Mar. 29, 2012

(54) Cargo-Mag

(76) Inventors: Edward Jay Mulholland, Careywood, ID (US); April Diane Mulholland, Careywood, ID (US)

(21) Appl. No.: 12/924,498

(22) Filed: Sep. 29, 2010

(51) Int. Cl. A47B 96/02; H01F 7/02; B60P 7/08

(52) U.S. Cl. 211/134; 410/121

(57) ABSTRACT

The Cargo-Mag is a cargo stabilization device. It is a Industrial strength plastic L shaped tool with high power magnets in the base allowing it to be placed on any metal surface such as a truck bed, in order to secure cargo against a vertical wall to hold it in place during transport. It can also be inverted and placed on any metal vertical surface such as a tool box or a refrigerator creating a shelf.

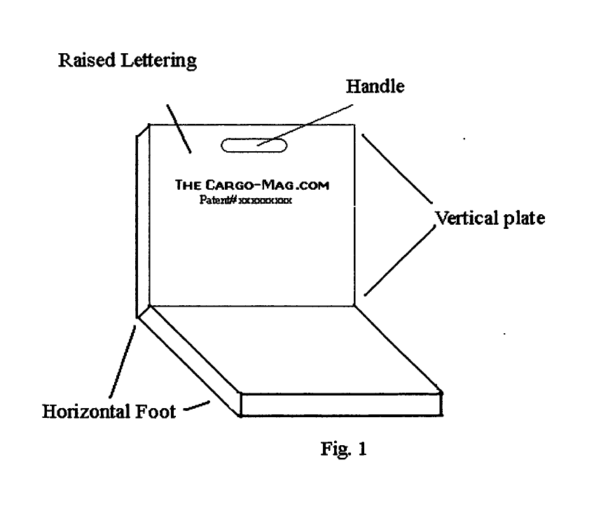

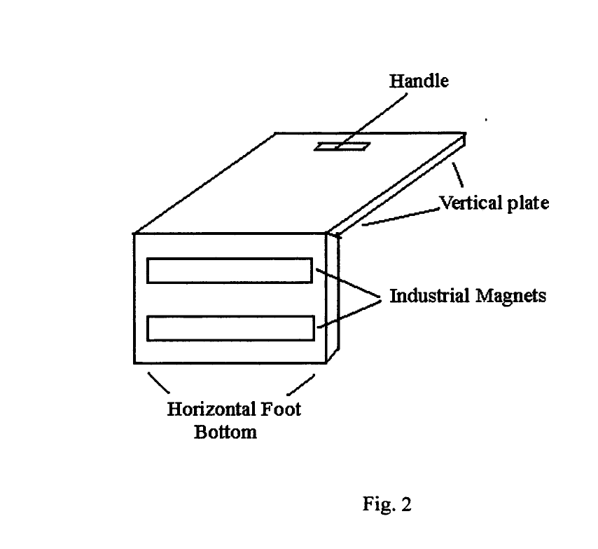

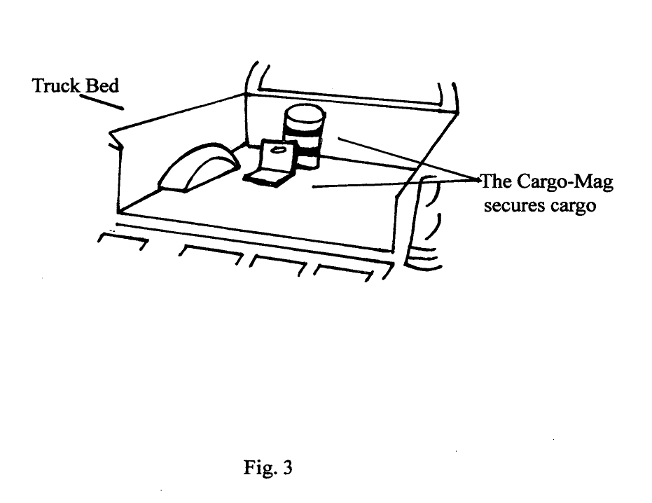

The Cargo-Mag is formed by molding plastic to form a vertical upstanding plate and magnetic horizontal foot so that the horizontal foot can lie on the metal surface with the vertical plate upstanding. The upper portion of the vertical plate has a cutout which acts as a handle to give leverage to brake the magnetic bond between The Cargo-Mag and the metal surface. (see FIG. 1) The underside of the horizontal foot carries a series of industrial strength magnets which are inset into the foot. (see FIG. 2) The magnets are sufficient to provide a magnetic bond between The Cargo-Mag and the metal surface so that the vertical plate secures cargo to other vertical surfaces. (see FIG. 3)

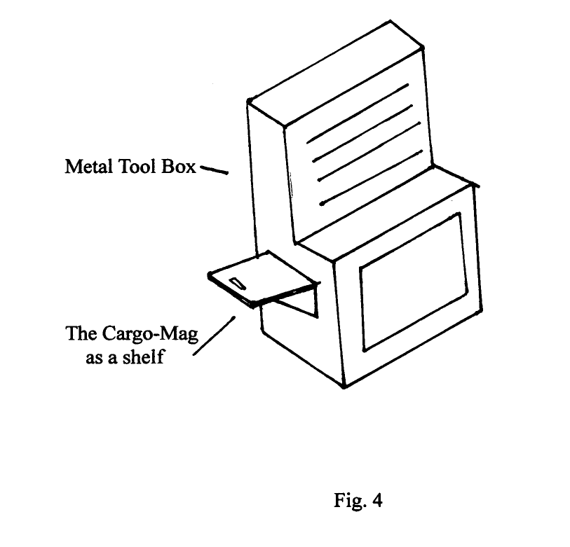

The Cargo-Mag can be used as magnetic shelf. By placing the magnetic horizontal foot against any vertical metal surface, the upstanding plate becomes a horizontal shelf. (see FIG. 4)

The Cargo-Mag is a L shaped device constructed of Industrial grade plastic with high powered magnets inset into the base. It is used to secure cargo from shifting while being transported in a truck bed, flat bed, cargo van or trailer deck or being worked on while on a metal work table. It may also be used as a shelf when places on a vertical metal surface such as a tool box or refrigerator.

FIG. 1. The front view of The Cargo-Mag pictured standing upright. The horizontal foot contains magnets which adhere to any metal surface in order to secure cargo from shifting.

FIG. 2 Bottom/Rear view of The Cargo-Mag. The horizontal foot contains magnets which adhere to any metal surface in order to secure cargo from shifting. The back of the vertical plate is placed against the cargo, wedging it against any vertical surface, such as a truck bed.

FIG. 3 The Cargo-Mag adheres to any metal surface in order to secure cargo from shifting. The back of the vertical plate is placed against the cargo, wedging it against any vertical surface such as a truck bed.

A. The Cargo-Mag is for use on a metal surface such as a truck bed, flatbed utility trailer, service trucks, metal work table, and any other flat metal work surface that require cargo or other materials to be secured. (see FIG. 3)

B. The Cargo-Mag also functions as a magnetic shelf. It can be secured magnetically to any vertical metal surface such as the side of a toolbox, washer and dryer, refrigerator, freezer, metal siding or any other metal surface. (see FIG. 4)
